(19) United States
(12) Patent Application Publication
(10) Pub. No.: US 2025/0105400 A1
(43) Pub. Date: Mar. 27, 2025

(54) BATTERY PACK MULTILAYERED THERMAL BARRIER

(71) Applicant: Ford Global Technologies, LLC, Dearborn, MI (US)

(72) Inventors: Bhaskara Rao Boddakayala, Troy, MI (US); Di Zhu, Novi, MI (US)

(21) Appl. No.: 18/802,541

(22) Filed: Aug. 13, 2024

Related U.S. Application Data
(60) Provisional application No. 63/594,623, filed on Oct. 31, 2023.
(60) Provisional application No. 63/585,443, filed on Sep. 26, 2023.

(51) Int. Cl. H01M 10/658; B60L 50/64; H01M 50/211; H01M 50/293

(52) U.S. Cl. CPC H01M 10/658; B60L 50/64; H01M 50/211; H01M 50/293; H01M 2220/20

(57) ABSTRACT

A multilayered thermal barrier of a traction battery pack includes an inner sandwich structure provided by first and second ceramic layers sandwiching a core layer and first and second foam layers sandwiching the inner sandwich structure. The core layer could be glass or mica. Mica layers can be positioned between the inner sandwich structure and the foam layers.

### CROSS-REFERENCE TO RELATED APPLICATIONS

This application claims the benefit of U.S. Provisional Application No. 63/585,443, which was filed on 26 Sep. 2023, and is incorporated herein by reference. This application additionally claims the benefit of U.S. Provisional Application No. 63/594,623, which was filed on 31 Oct. 2023, and is incorporated herein by reference.

### TECHNICAL FIELD

This disclosure relates generally to thermal barriers used within battery packs and, more particularly, to multilayered thermal barriers.

### BACKGROUND

Battery packs can include cell stacks having multiple battery cells. Within the cell stacks, a mica layer can be positioned between groups of the battery cells. The mica layer can slow thermal propagation between the groups of cells.

For example, with reference to FIG. 1, a battery pack of the prior art includes a cell stack having a plurality of battery cells 2. A prior art thermal barrier 4 includes a mica layer 6 disposed between groups of battery cells 2. Foam layers 8 positioned on opposing sides of the mica layer 6, can accommodate expansion of the battery cells 2.

### SUMMARY

In some aspects, the techniques described herein relate to a multilayered thermal barrier of a traction battery pack, including: an inner sandwich structure provided by first and second ceramic layers sandwiching a core layer; and first and second foam layers sandwiching the inner sandwich structure.

In some aspects, the techniques described herein relate to a multilayered thermal barrier, wherein the core layer is glass.

In some aspects, the techniques described herein relate to a multilayered thermal barrier, wherein the core layer is mica.

In some aspects, the techniques described herein relate to a multilayered thermal barrier, wherein the first and second ceramic layers are each thinner than the core layer.

In some aspects, the techniques described herein relate to a multilayered thermal barrier, wherein the first and second ceramic layers are adhesively secured directly to the core layer.

In some aspects, the techniques described herein relate to a multilayered thermal barrier, further including first and second mica layers, the first mica layer disposed between the first ceramic layer and the first foam layer, the second mica layer disposed between the second ceramic layer and the second foam layer.

In some aspects, the techniques described herein relate to a multilayered thermal barrier, wherein the core layer is a third mica layer.

In some aspects, the techniques described herein relate to a multilayered thermal barrier, wherein the core layer is glass.

In some aspects, the techniques described herein relate to a multilayered thermal barrier, wherein the first mica layer is adhesively secured to both the first foam layer and the first ceramic layer, wherein the second mica layer is adhesively secured to both the second foam layer and the second ceramic layer.

In some aspects, the techniques described herein relate to a multilayered thermal barrier, wherein the first foam layer is a first polyurethane foam layer, wherein the second foam layer is a second polyurethane foam layer.

In some aspects, the techniques described herein relate to a traction battery pack assembly having the multilayered thermal barrier, and further including a cell stack having a plurality of battery cells disposed along a cell stack axis, the multilayered thermal barrier positioned axially between at least one first battery cell of the plurality of battery cells and at least one second battery cell of the plurality of battery cells.

In some aspects, the techniques described herein relate to a traction battery pack assembly, including: a cell stack including at least one first battery cell, at least one second battery cell, and a multilayered thermal barrier assembly arranged to limit thermal energy transfer between the at least one first battery cell and the at least one second battery cell, the multilayered thermal barrier assembly including an inner sandwich structure sandwiched between first and second foam layers.

In some aspects, the techniques described herein relate to a traction battery pack assembly, wherein the inner sandwich structure includes first and second ceramic layers sandwiching a core layer.

In some aspects, the techniques described herein relate to a traction battery pack assembly, wherein the core layer is mica.

In some aspects, the techniques described herein relate to a traction battery pack assembly, wherein the core layer is glass.

In some aspects, the techniques described herein relate to a traction battery pack assembly, wherein the at least one first battery cell includes four first battery cells, wherein the at least one second battery cell includes four second battery cells.

In some aspects, the techniques described herein relate to a traction battery pack assembly, further including first and second mica layers, the first mica layer disposed between the inner sandwich structure and the first foam layer, the second mica layer disposed between the inner sandwich structure and the second foam layer.

In some aspects, the techniques described herein relate to a traction battery pack assembly, wherein the inner sandwich structure includes a third mica layer.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

FIG. 1 shows a schematic side view of a portion of a prior art cell stack including a thermal barrier.

FIG. 2 schematically illustrates an electrified vehicle.

FIG. 3 illustrates a traction battery pack of the electrified vehicle of FIG. 2.

FIG. 4 illustrates a cell stack of the traction battery pack of FIG. 3.

FIG. 5 illustrates a close-up view of an area of the cell stack of FIG. 4.

FIG. 6 illustrates a perspective view of a multilayered thermal barrier assembly from the cell stack of FIG. 5 according to an exemplary embodiment of the present disclosure.

FIG. 7 is a schematic end view of the multilayered thermal barrier assembly of FIG. 6.

FIGS. 8-23 show multilayered thermal barriers according to other exemplary embodiments of the present disclosure.

### DETAILED DESCRIPTION

This disclosure details multilayered thermal barrier assemblies for traction battery packs. The multilayered thermal barrier assemblies can inhibit the transfer of thermal energy inside the traction battery pack. In some embodiments, the multilayered thermal barriers provide barriers to effluent particles along with heat dissipation and thermal insulation to contain thermal energy and delay or stop thermal propagation between groups of battery cells. The multilayered thermal barriers can prolong the time for thermal energy to transfer through the thermally conductive connections. This can result in a longer propagation time or at least delayed thermal propagation to cells within a cell stack.

FIG. 2 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEVs), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In an embodiment, the electrified vehicle 10 is a full electric vehicle propelled solely through electric power, such as by one or more electric machines 12, without any assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cell groupings capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 in other examples.

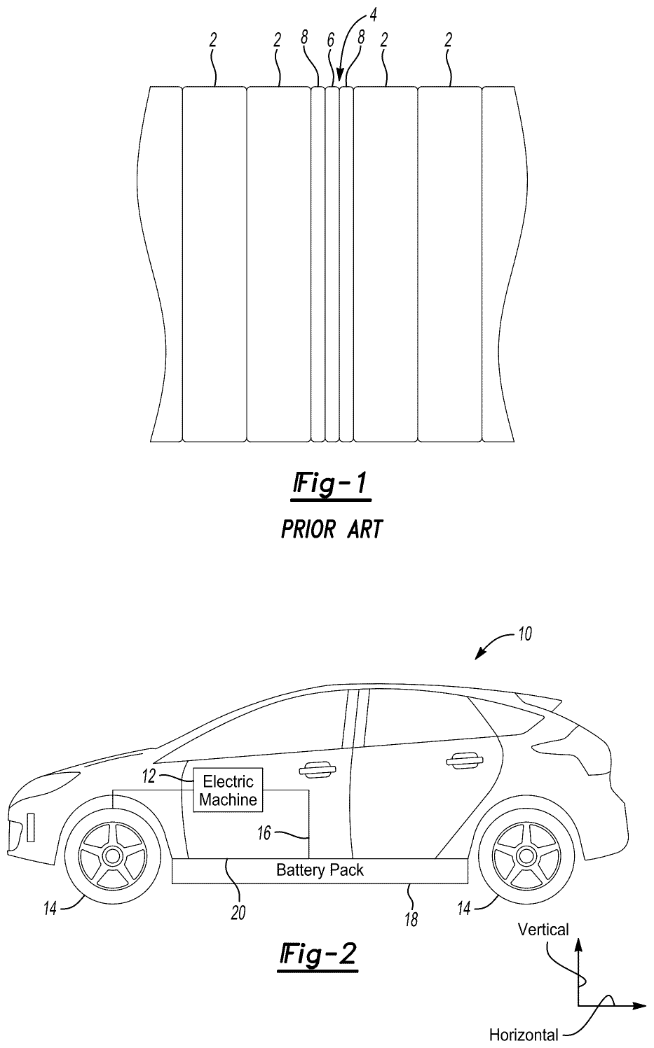

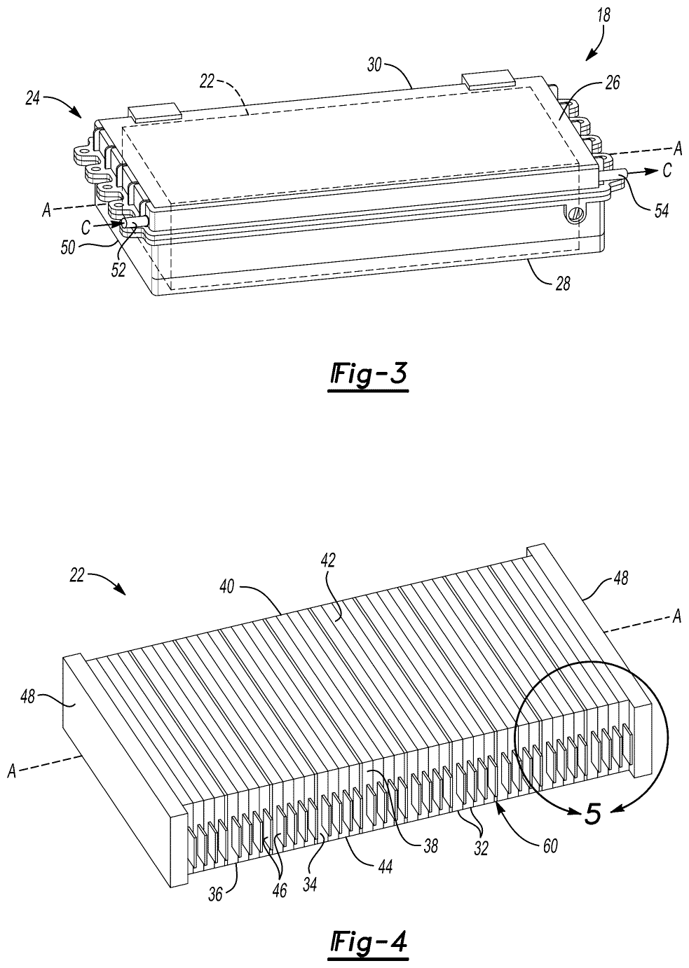

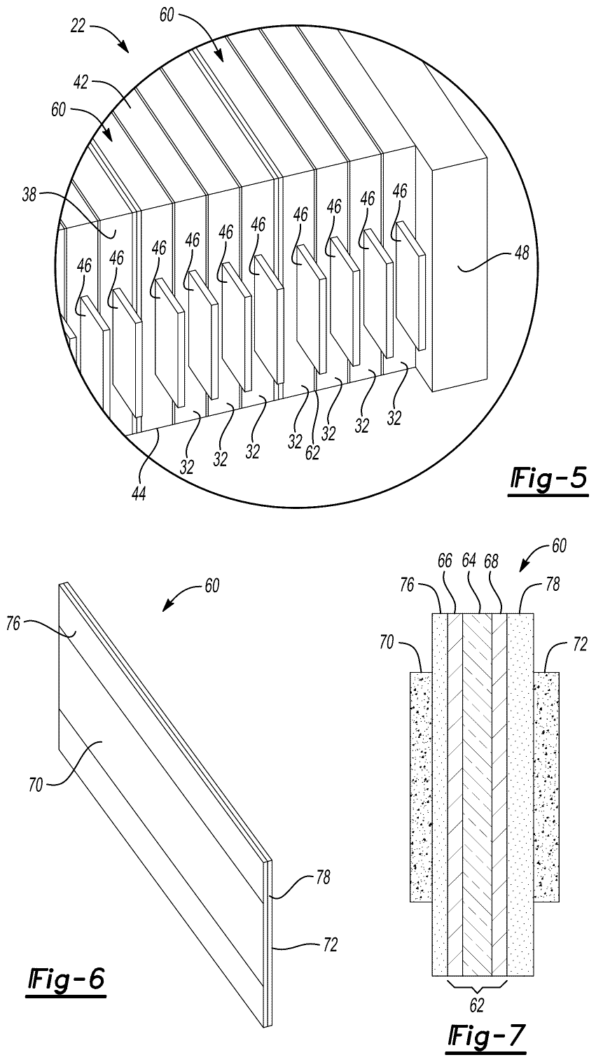

FIG. 3-5 illustrate additional details associated with the traction battery pack 18 of the electrified vehicle 10. The traction battery pack 18 may include one or more cell stacks 22 (e.g., one shown) housed within an interior area 30 of an enclosure assembly 24. The enclosure assembly 24 of the traction battery pack 18 may include an enclosure cover 26 and an enclosure tray 28. The enclosure cover 26 is positioned vertically above the enclosure tray 28. However, the enclosure cover 26 could be arranged below or to a side of the enclosure tray 28. Various terms such as “above,” “below,” “top,” and “bottom” are used relative to the arrangement of the components of the traction battery pack 18 in the various drawings and should not otherwise be deemed limiting. These terms are with reference to the general orientation of the traction battery pack 18 when installed on the electrified vehicle 10 of FIG. 1. Vertical, for purposes of this disclosure, is also with reference to ground and how the traction battery pack 18 is oriented when installed on the electrified vehicle 10.

The enclosure cover 26 may be secured (e.g., bolted, welded, adhered, etc.) to the enclosure tray 28 to provide the interior area 30 for housing the cell stacks 22 and other battery internal components (e.g., busbars, control modules and other electronics, etc.) of the traction battery pack 18. The size, shape, and configuration of the enclosure assembly 24 may vary within the scope of this disclosure.

Each cell stack 22 may include a plurality of individual battery cells 32 that are arranged together along a cell stack axis A between opposing end plates 48. The battery cells 32 store and supply electrical power for powering various components in order to support electric propulsion of the electrified vehicle 10.

In an embodiment, the battery cells 32 are lithium-ion pouch cells. However, battery cells having other geometries (prismatic, cylindrical, etc.) and/or chemistries (nickel-metal hydride, lead-acid, etc.) could alternatively be utilized within the scope of this disclosure.

Although a specific number of cell stacks 22 and battery cells 32 are illustrated in the various figures of this disclosure, the traction battery pack 18 could include any number of the cell stacks 22, with each cell stack 22 having any number of individual battery cells 32.

Each battery cell 32 may include a first face 34, a second face 36 opposite the first face 34, a first end 38, a second end 40 opposite the first end 38, a top side 42, and a bottom side 44 opposite the top side 42. The first face 34 and the second face 36 establish major side surfaces of the battery cells 32, and the first end 38, the second end 40, the top side 42, and the bottom side 44 establish minor side surfaces of the battery cell 32. The first face 34 and the second face 36 therefore exhibits a greater surface area than any of the first end 38, the second end 40, the top side 42, and the bottom side 44.

A tab terminal 46 project outwardly from each of the first end 38 and the second end 40 of the battery cells 32. The battery cells 32 may thus be considered to be “side-oriented” within the cell stacks 22. The tab terminals 46 may be connected to busbars (not shown) in order to electrically connect the battery cells 32 of each cell stack 22.

The cell stack 22 includes one or more multilayered thermal barrier assemblies 60 arranged along the respective cell stack axis A of each cell stack 22. In an embodiment, groups of four individual battery cells 32 are separated by the multilayered thermal barrier assemblies 60 along the cell stack axis A. However, other configurations are contemplated within the scope of this disclosure, and it should be apparent those having the benefit of this disclosure that the cell stack 22 could include any number of and any arrangement of battery cells 32 and multilayered thermal barrier assemblies 60.

The battery cells 32 may be arranged such that the faces 34, 36 of one battery cell 32 are in direct contact with one of the faces 34 or 36 of a neighboring battery cell 32, or of a neighboring thermal barrier assembly 60 of the cell stack 22. The battery cells 32, thermal barrier assemblies 60, and cell expansion pads 62 may be held in compression relative to one another within the cell stack 22 to provide the face-to-face arrangement. The compression may be applied by the end plates 48 of the cell stack 22, for example. However, other configurations are contemplated within the scope of this disclosure.

With reference to FIG. 7 and continuing reference to FIGS. 2-6, the multilayered thermal barrier 60, in this example, includes an inner sandwich structure 62 provided by a core layer 64 sandwiched between a first ceramic layer 66 and a second ceramic layer 68. The multilayered thermal barrier 60 has the inner sandwich structure 62 sandwiched between a first foam layer 70 and a second foam layer 72.

In this example, the core layer 64 is a glass silicone layer that about 0.5 millimeters thick. The first ceramic layer 66 and the second ceramic layer 68 are each thinner than the core layer 64. The first ceramic layer 66 and the second ceramic layer 68 can be adhesively secured directly the core layer 64 using, for example, an adhesive tape.

In a variation of the multilayered thermal barrier 60, the core layer 64 could be a mica layer, rather than glass silicone.

The first foam layer 70 and the second foam layer 72 can accommodate expansion of the cells 32 along the axis A. The first foam layer 70 and the second foam layer 72 can be a polyurethane foam. The first foam layer 70 and the second foam layer 72 can have a vertical height that is less than the other portions of the multilayered thermal barrier 60.

The example multilayered thermal barrier 60 additionally includes a first mica layer 76 and a second mica layer 78. The first mica layer 76 is disposed between the first ceramic layer 66 and the first foam layer 70. The second mica layer is disposed between the second ceramic layer 68 and the second foam layer 72.

The first mica layer 76 can be adhesively secured directly to both the first foam layer 70 and the first ceramic layer 66, The second mica layer 78 is adhesively secured to both the second foam layer 72 and the second ceramic layer 68.

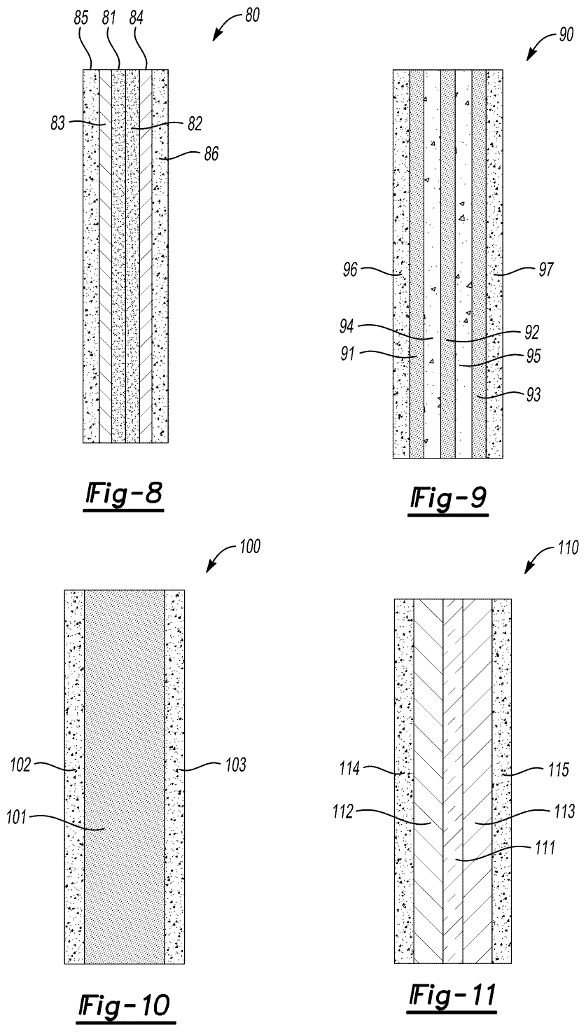

Additional exemplary embodiments of the multilayered thermal barrier 60 will now be described in connection with FIGS. 8-18. Some of the example multilayered thermal barriers can include intumescent endothermic aerogel layers in a sandwiched configuration. The multilayered thermal barriers can also include fiberglass, steel, graphene layers, or some combination of these. Adhesives, such as adhesive tape, can be used to join the layers.

The intumescent materials in some of these examples can activate in response to a thermal event in one or more battery cells when temperature exceed 200° C. The aerogel layers in some of these examples are endothermic in nature and can absorb heat energy during a thermal event and can contain some portion of convection effects of hot gasses to minimize effect on neighboring cells.

The metal layers and/or graphene layers of some of these examples help to dissipate thermal energy and to distribute thermal energy across the endothermic aerogel layers to activate the endothermic aerogel layers.

The examples that include an outer layer of mica can rely on that layer to provides a barrier from cell particle effluents, which may be vented from one or more of the battery cells 32 during a thermal event.

With reference to FIG. 8, another exemplary embodiment of a multilayered thermal barrier 80 for use in the battery pack 18 includes two aerogel layers 81, 82 sandwiched between steel layers 83, 84. Foam layers 85, 86 sandwich the aerogel layers 81, 82 and the steel layers 83, 84.

With reference to FIG. 9, another exemplary embodiment of a multilayered thermal barrier 90 for use in the battery pack 18 includes three mica layers 91, 92, 93 that alternate with fiberglass layers 94, 95. The mica layers 91, 92, 93, and the fiberglass layers 94, 95 are sandwiched between foam layers 96, 97.

With reference to FIG. 10, another exemplary embodiment of a multilayered thermal barrier 100 for use in the battery pack 18 includes an adhesive layer 101, which can be a glass silicone tape with an adhesive backing, sandwiched between foam layers 102, 103.

With reference to FIG. 11, another exemplary embodiment of a multilayered thermal barrier 110 for use in the battery pack 18 includes a layer of steel 111 and two layers of aerogel 112, 113 sandwiched between foam layers 114, 115.

With reference to FIG. 12, another exemplary embodiment of a multilayered thermal barrier 120 for use in the battery pack 18 includes a ceramic layer 121 sandwiched between two layers of steel 122, 123, which is then sandwiched between foam layers 125, 126. The multilayered thermal barrier 120 can further include PET film layers.

With reference to FIG. 13, another exemplary embodiment of a multilayered thermal barrier 130 for use in the battery pack 18 includes a ceramic layer 131 sandwiched between two layers of soft mica 132, 133, which is then sandwiched between foam layers 134, 135.

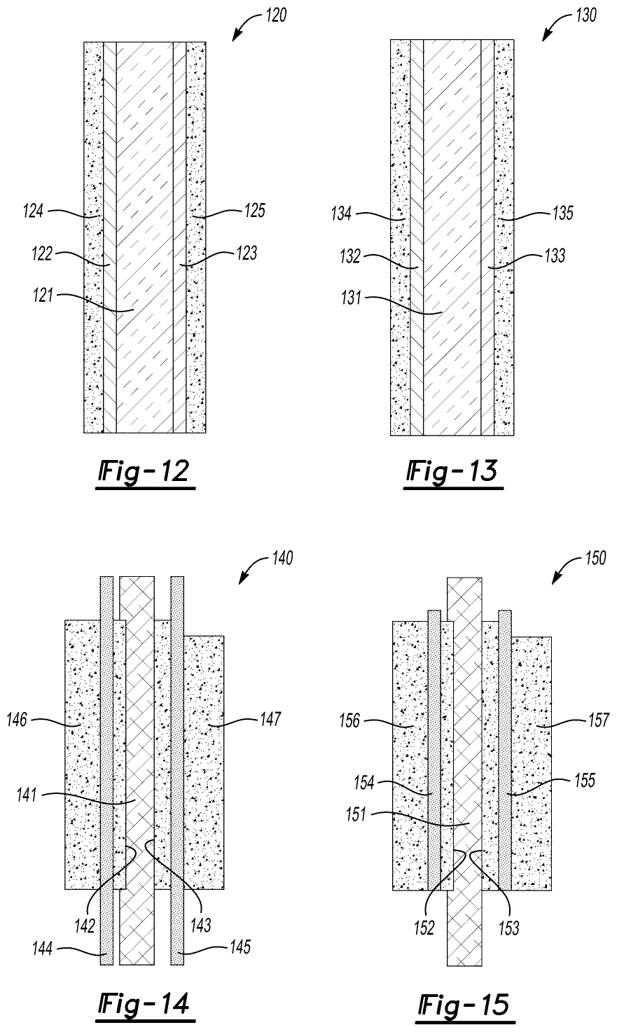

With reference to FIG. 14, another exemplary embodiment of a multilayered thermal barrier 140 for use in the battery pack 18 includes a mica layer 141, which can be hard mica, sandwiched between PET/graphene layers 142, 143 and aerogel layers 144, 145, which is then sandwiched between foam layers 146, 147. The mica layer 141 extends outward from the axis A of the cell stack 22 past the PET/graphene layers 142, 143. The mica layer 141 provide a picture frame structure about the PET/graphene layers 142, 143. The PET/graphene layers 142, 143 can be laminated together.

When a multilayered thermal barrier, such as the multilayered thermal barrier 140, has a picture frame structure, a framing layer (here the mica layer 141) extends outward past another inner layer. The inner layer, the PET/graphene layers 142, 143 can be embedded into the framing layer. The edges of the inner layer, which can be sharp, are protected by the framing layer. This configuration omit an adhesive tape, which can save space.

With reference to FIG. 15, another exemplary embodiment of a multilayered thermal barrier 150 for use in the battery pack 18 includes a layer of hard mica 151 sandwiched between PET/steel layers 152, 153 and then aerogel layers 154, 155. These layers are then sandwiched between foam layers 156, 157. The hard mica 151 and aerogel layers 154, 155 extend outward from the axis A of the cell stack 22 past the PET/steel layers 152, 153. The mica 151 and aerogel layers 154, 155 provide a picture frame structure about the PET/steel layers 152, 153.

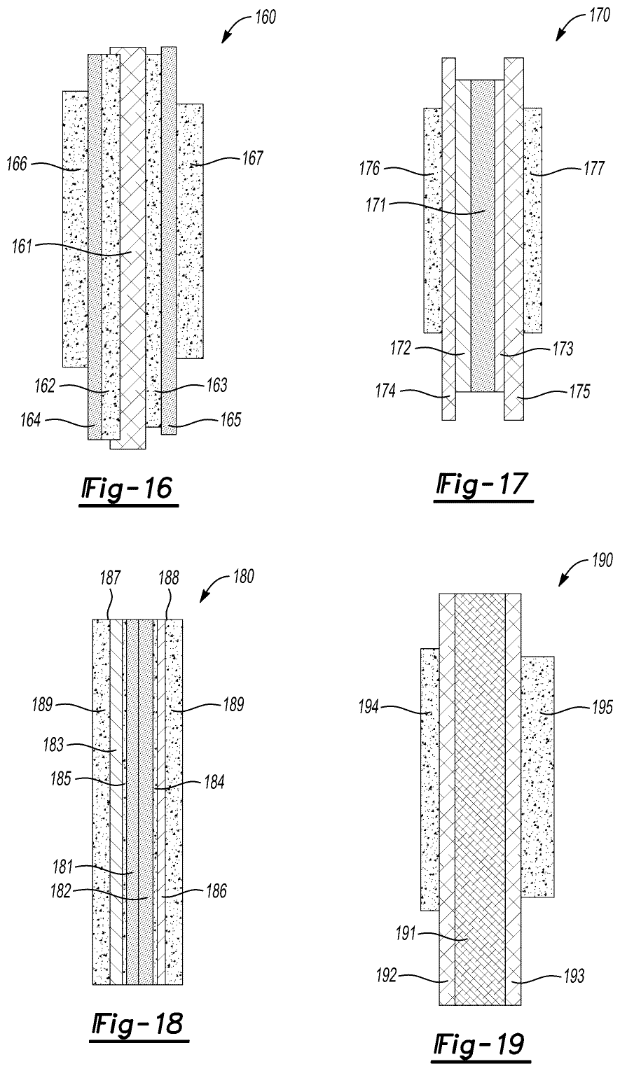

With reference to FIG. 16, another exemplary embodiment of a multilayered thermal barrier 160 for use in the battery pack 18 includes a layer 161 of hard mica sandwiched between steel 162, 163 and soft mica layers 164, 165, which are then sandwiched between foam layers 166, 167.

With reference to FIG. 17, another exemplary embodiment of a multilayered thermal barrier 170 for use in the battery pack 18 includes a layer of aerogel 171 sandwiched between steel layers 172, 173 and the soft mica layers 174, 175. These layers are then sandwiched between foam layers 176, 177. The soft mica layers 174, 175 and aerogel layer 171 extend outward from the axis A of the cell stack 22 past the steel layers 172, 173. The soft mica layers 174, 175 and aerogel layer 171 provide a picture frame structure about the steel layers 172, 173.

With reference to FIG. 18, another exemplary embodiment of a multilayered thermal barrier 180 for use in the battery pack 18 includes a double layer of aerogel 181, 182 sandwiched between layers of graphene 183, 184, steel layers 185, 186, and then PET layers 187, 188. These layers are then sandwiched between two foam layers 189.

With reference now to FIGS. 19-23, other example multilayered thermal barriers can include at least one endothermic glass silicone layer that is sandwiched between layers of another material. The endothermic can activate in response to a thermal event in one or more battery cells when temperature exceed 200° C. The aerogel layers are endothermic in nature and can absorb heat energy during a thermal event and can contain some portion of convection effects of hot gasses to minimize effect on neighboring cells.

Ceramic coatings and glass silicon layers can help to dissipate thermal energy and to distribute thermal energy across the endothermic aerogel layers to activate the endothermic aerogel layers.

With reference to FIG. 19, another exemplary embodiment of a multilayered thermal barrier 190 for use in the battery pack 18 includes a checkered mica layer 191 sandwiched between hard mica layers 192, 193 and then foam layers 194, 195. The checkered mica layer 191 can include mica material surrounded by air gaps or an endothermic filler, such as a mixture of sodium silicate (40-65%) and aluminum nitride (25-35%), or a mixture sodium silicate (40-65%) and aluminum oxide (25-35%). The foam layers 194, 195 do not extend as far from the axis A as the other layers.

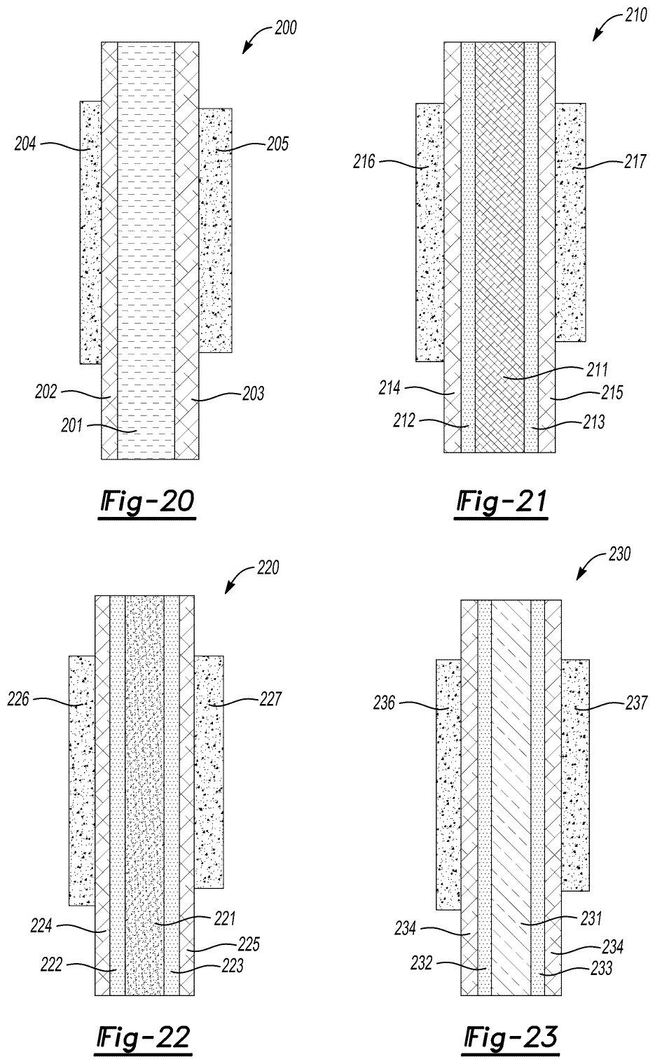

With reference to FIG. 20, another exemplary embodiment of a multilayered thermal barrier 200 for use in the battery pack 18 includes an endothermic bag layer 201 sandwiched between hard mica layers 202, 203 and then foam layers 204, 205. The endothermic bag layer 201 includes a bag made from, for example, polyimide or polyethylene terephthalate, filled with an endothermic material like sodium silicate, for example. The bag of the endothermal bag layer 201 can additionally include foam and electrical insulation materials, such as aluminum nitrate and aluminum oxide. The foam layers 204, 205 do not extend as far as the other layers.

With reference to FIG. 21, another exemplary embodiment of a multilayered thermal barrier 210 for use in the battery pack 18 includes a mica layer 211 sandwiched between ceramic layers 212, 213, which are then sandwiched between other mica layers 214, 215 and then foam layers 216, 217. The foam layers 216, 217 do not extend as far as the other layers.

With reference to FIG. 22, another exemplary embodiment of a multilayered thermal barrier 220 for use in the battery pack 18 includes an aerogel layer 221 sandwiched between ceramic layers 222, 223, which are then sandwiched between mica layers 224, 225 and then foam layers 226, 227. The foam layers 226, 227 do not extend as far as the other layers.

With reference to FIG. 23, another exemplary embodiment of a multilayered thermal barrier 230 for use in the battery pack 18 includes a glass/silicone layer 231 sandwiched between ceramic layers 232, 233, which are then sandwiched between mica layers 234, 235 and then foam layers 236, 237. The foam layers 236, 237 do not extend as far as the other layers. A thickness of the glass/silicone layer 231 is 0.3 millimeters in this example.

Features of some of the disclosed examples can include multilayered thermal barriers having an intumescent endothermal aerogel layer to reduce thermal conductivity and to absorb heat absorption. An activation temperature for the layer can be around 200 Celsius. Varied combinations of steel layers, graphene layers, mica, and/or aerogel can be used to achieve high thermal dissipation and thermal insulation values at high temperature using different combinations steel, graphene with mica and aerogel. The multilayered thermal barriers can include at least one checkered mica layer. The multilayered thermal barriers can include at least one ceramic layer.

Features of the disclosed examples can include multilayered thermal barriers having an intumescent endothermal aerogel layer to reduce thermal conductivity and to absorb heat absorption. An activation temperature for the layer can be around 200 Celsius. Varied combinations of steel layers, graphene layers, mica, and/or aerogel can be used to achieve high thermal dissipation and thermal insulation values at high temperature using different combinations steel, graphene with mica and aerogel.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A multilayered thermal barrier of a traction battery pack, comprising:
an inner sandwich structure provided by first and second ceramic layers sandwiching a core layer; and
first and second foam layers sandwiching the inner sandwich structure.

2. The multilayered thermal barrier of claim 1, wherein the core layer is glass.

3. The multilayered thermal barrier of claim 1, wherein the core layer is mica.

4. The multilayered thermal barrier of claim 1, wherein the first and second ceramic layers are each thinner than the core layer.

5. The multilayered thermal barrier of claim 1, wherein the first and second ceramic layers are adhesively secured directly to the core layer.

6. The multilayered thermal barrier of claim 1, further comprising first and second mica layers, the first mica layer disposed between the first ceramic layer and the first foam layer, the second mica layer disposed between the second ceramic layer and the second foam layer.

7. The multilayered thermal barrier of claim 6, wherein the core layer is a third mica layer.

8. The multilayered thermal barrier of claim 6, wherein the core layer is glass.

9. The multilayered thermal barrier of claim 6, wherein the first mica layer is adhesively secured to both the first foam layer and the first ceramic layer, wherein the second mica layer is adhesively secured to both the second foam layer and the second ceramic layer.

10. The multilayered thermal barrier of claim 9, wherein the first foam layer is a first polyurethane foam layer, wherein the second foam layer is a second polyurethane foam layer.

11. A traction battery pack assembly having the multilayered thermal barrier of claim 1, and further comprising a cell stack having a plurality of battery cells disposed along a cell stack axis, the multilayered thermal barrier positioned axially between at least one first battery cell of the plurality of battery cells and at least one second battery cell of the plurality of battery cells.

12. A traction battery pack assembly, comprising:
a cell stack including at least one first battery cell, at least one second battery cell, and a multilayered thermal barrier assembly arranged to limit thermal energy transfer between the at least one first battery cell and the at least one second battery cell, the multilayered thermal barrier assembly including an inner sandwich structure sandwiched between first and second foam layers.

13. The traction battery pack assembly of claim 12, wherein the inner sandwich structure includes first and second ceramic layers sandwiching a core layer.

14. The traction battery pack assembly of claim 13, wherein the core layer is mica.

15. The traction battery pack assembly of claim 13, wherein the core layer is glass.

16. The traction battery pack assembly of claim 12, wherein the at least one first battery cell includes four first battery cells, wherein the at least one second battery cell includes four second battery cells.

17. The traction battery pack assembly of claim 12, further comprising first and second mica layers, the first mica layer disposed between the inner sandwich structure and the first foam layer, the second mica layer disposed between the inner sandwich structure and the second foam layer.

18. The traction battery pack assembly of claim 17, wherein the inner sandwich structure includes a third mica layer.
